(19) United States
(12) Patent Application Publication
(10) Pub. No.: US 2006/0035138 A1
(43) Pub. Date: Feb. 16, 2006

(54) Evaporative cooling for aqueous batteries

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/195,583

(22) Filed: Aug. 2, 2005

Related U.S. Application Data
(60) Provisional application No. 60/598,403, filed on Aug. 2, 2004.

(51) Int. Cl. H01M 10/50; H01M 2/12

(52) U.S. Cl. 429/50; 429/120; 429/71

(57) ABSTRACT

A method and device for cooling the electrolyte of aqueous battery cells such as lead acid batteries. The method includes the steps of delivering non-saturated gas to the electrolyte of in the battery cell, contacting said non-saturated gas with said electrolyte so that water from said electrolyte evaporates and thereby cools said electrolyte, and allowing the gas to escape from said battery cell, thereby removing heat from the electrolyte. An apparatus for carrying out the method is also provided. A fluid conduit is positioned to deliver the cooling air to the electrolyte within the cell. At least one pump delivers the air to the fluid conduit.

### CROSS REFERENCE TO RELATED APPLICATION

This application claims the priority of U.S. Provisional Application No. 60/598,403 filed Aug. 2, 2004, which is hereby incorporated herein by reference.

### FIELD OF THE INVENTION

The present invention is related to aqueous batteries, and more particularly to methods and devices for cooling the electrolyte of such batteries.

### BACKGROUND

Aqueous batteries, such as industrial batteries that are typically made up of multiple battery cells connected in series, are used widely in industry in such uses as electric vehicles, e.g., fork lift trucks. As well known in the art, each cell contains positive and negative plates (electrodes) immersed in an electrolyte. Such batteries are used in service until depleted of charge, at which time the battery is removed and replaced with a freshly charged battery. The removed depleted battery is connected to a charger to be recharged. This method of operation requires several batteries for each vehicle, and a charging room with chargers where the depleted batteries can be recharged. This method of operation also requires the swapping of batteries each time a depleted battery is replaced.

Significant benefits have been obtained with a recent development that provides for fast or “rapid-charging” of industrial batteries, particularly in the material handling industry, e.g., battery powered fork lift trucks. Rapid-charging has eliminated the need for maintaining multiple batteries for each fork lift truck and the need for fixed battery charging rooms and battery charging equipment for the extra batteries. With the rapid charge process, only one battery per truck is required, which is charged quickly while still connected to the truck, thus providing great savings in costs and time.

Unfortunately, the rapid charge process has created problems that negatively affect the battery. One problem is that rapid charging can cause the battery cells to get very hot, and high cell temperatures cause the batteries to fail prematurely. For instance, batteries that are rapid charged often fail in less than two years whereas their normal life expectancy is 5 to 7 years. Since batteries for trucks can cost several thousands of dollars, early failure is very costly for the battery user. Thus significant improvements can be obtained by cooling the batteries to remove the excess heat, thereby extending the battery life.

Rapid charge also has a second problem. When a battery is charged at a very high rate, the charging voltage at the bottom of the battery plates is lower than the charging voltage at the top of the plates due to the voltage drop of the plates themselves. This effect tends to undercharge the bottom of the plates and overcharge the top of the plates.

In lead-acid batteries, this condition is further exacerbated by a third problem, also related to rapid-charge. Batteries used on these chargers are usually “opportunity charged” as the situation permits. This implies partial charging which, in turn, leads to a phenomenon of acid stratification. During a partial charge, strong, dense acid emerging from the plates tends to sink to the bottom of the cell, leaving weak, dilute acid at the top of the cell. In essence, this is like having two half-cells inside the same cell container but with different electrolytes. A cell with strong acid requires a higher charge voltage than a cell with weak acid. Yet, in the case of rapid-charge, the bottom of the plates has a lower charge voltage than the top due to the excessive voltage drop as described in the second problem above. Unless the electrolyte is mixed, it is likely that the charging will be limited to the top of the plates, leaving the bottom of the plates discharged and ultimately seriously damaged. For example, in lead acid batteries, it is known that stratification can cause the active material at the bottom of the negative plates to fall off the grids as lead sulfate. Nickel alkaline cells do not have an electrolyte that stratifies and therefore do not require a mixing system. Nevertheless, such cells also run hot and may benefit from cooling.

A known solution to the stratification problem of lead acid cells is air mixing of the electrolyte. Each cell is equipped with a small air tube that channels compressed air from an external source into the lower regions of the cell. The resulting air bubbles rise to the surface and mix the acid. The system is generally used to reduce the amount of overcharge required for normal operation. This, in turn, reduces electricity usage in the charging cycle, provides a more uniform current density and thus reduces the amount of water lost by electrolysis—which is the traditional way to mix the cell electrolyte. The amount of air used in this conventional method is deliberately minimized to prevent evaporation of water from the electrolyte.

While conventional air-mix systems can prevent stratification, they do not supply enough air to cool the battery significantly. Typically with existing air-mix systems, the air flow to the cells is supplied from a pump in the battery charger which also includes the control system, timers, etc., that govern the on and off times for the air flow. The air is delivered via flexible tubes to the individual air-tubes in the cells. In rare cases, air pumps may be mounted on the trucks or even on the batteries themselves.

Accordingly, it is an object of the present invention to provide a means of cooling the electrolyte to mitigate and eliminate the detrimental effects of rapid cooling. Another object is to provide an electrolyte cooling system the can also eliminate other problems such as stratification.

### SUMMARY OF THE INVENTION

The present invention provides a novel method of cooling an aqueous electrolyte battery cell by causing the evaporation of water from the electrolyte. In one form, the method includes delivering non-saturated gas to the electrolyte of the battery, contacting the non-saturated gas with the electrolyte so that water from the electrolyte evaporates and thereby cools the electrolyte, and allowing the gas to escape from the battery cell with the vapor. This process is believed to be an evaporative cooling process whereby the heat of evaporation comes from the electrolyte itself, thereby lowering the temperature. A device for carrying the method is also provided.

### BRIEF DESCRIPTION OF THE DRAWINGS

The following detailed description will be better understood when read in conjunction with the Figures appended hereto. For the purpose of illustrating the invention, there is shown in the drawings a preferred embodiment. It is understood, however, that this invention is not limited to this embodiment or the precise arrangements shown.

FIG. 1 is a schematic view of a battery cell in accordance with the present invention;

FIG. 2 is a top view of an eighteen cell battery illustrating in schematic form an cooling air distribution system and a water distribution system; and

FIG. 3 is a schematic view of a fork lift truck type vehicle having a battery using an electrolyte cooling system in accordance with the present invention.

### DETAILED DESCRIPTION OF THE INVENTION

The present invention provides a novel means for cooling aqueous batteries. Although the invention will be discussed with reference to industrial batteries, and more particularly to lead acid type industrial batteries, it will be appreciated that the present invention can be applied to other types of batteries that can benefit from cooling.

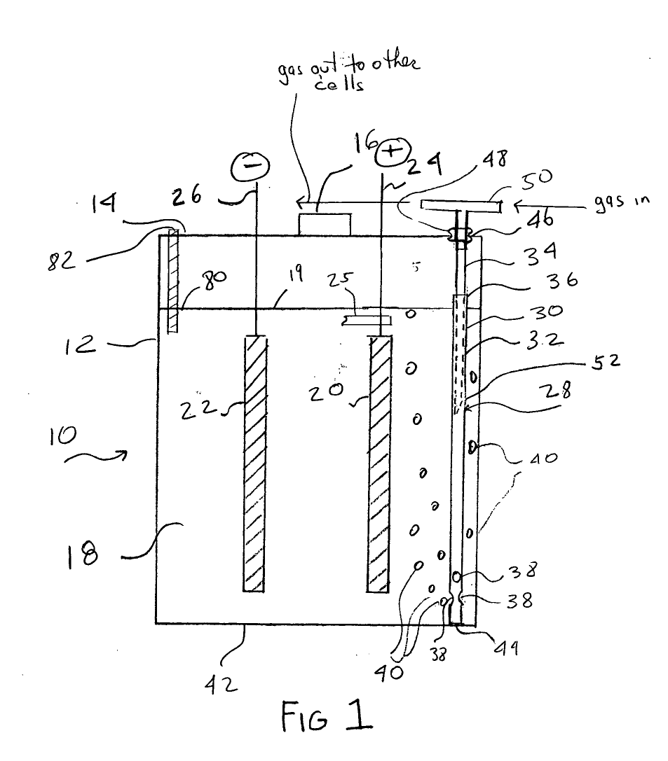

With reference to FIG. 1, a battery cell 10 is illustrated. The battery cell 10 is a single cell that typically is combined with multiple such cells 10 to form a battery. For example, lead acid batteries formed of 12, 18 and 24 such cells electrically connected in series are typical. The cell 10 has a housing 12, a housing cover 14 closing the top of the housing 12 and which has a vent 16 through which gasses from within the cell 10 can vent. An aqueous electrolyte 18 is provided in the housing, such as sulfuric acid for lead acid cells and sodium hydroxide for nickel alkaline cells. Immersed in the liquid electrolyte 18 is a positive electrode 20 and a negative electrode 22, both of which are typically formed as multiple plates which are electrically connected to their respective terminals 24, 26 by a strap as is known in the art.

A fluid conduit 28 delivers gas used for cooling to the electrolyte 18. In the preferred embodiment, the conduit 28 takes the form of a tube 30 having a first tube section 32 within the cell 10 extending into the electrolyte 18 to the bottom of the cell 10, and a second tube section 34 extending into the cell 10, preferably from above the housing cover 14, and which is connected to a top end 36 of the first tube 32.

The fluid conduit 28 has at least one outlet 38 positioned in a lower portion of the electrolyte 18 to maximize the travel of gas bubbles 40 leaving the openings 38 through the electrolyte 18. In the present embodiment, four openings 30 are provided in the first tube 32 above a bottom 42 of the cell housing 12 so as to be above any sediment that may build up along the bottom of a typical battery cell 10. For example, the lower openings 38a and 38b, 180 degrees apart from one another, might be 1¼ inch from the bottom 44 of the tube 30, and openings 30c and 30d, also 180 degrees apart from one another and 90 degrees from the openings 30a and 30c, 1½ inches from the bottom 44 of the tube 32. The bottom 44 of the tube 32 can be open, but as the tube rests against the bottom 42 of the cell 10 and possibly in sediment, little gas may exit there.

In the preferred embodiment, the first tube 32 is installed near the positive strap 25 corner of the cell 10 during manufacture of the cell and prior to installation and sealing of the cover 14 to the housing 12. (The positive strap 25, shown partially and schematically, electrically connects together all of the positive plates as is known in the art). The openings 30 can be drilled into the tube section 32. The length of the first tube section 32 is chosen so that the top 36 of the first tube section 32 is preferably above the strap 25 of the cell 10, and to provide the best fit for the first tube 32 in the cell 10.

After the cover 14 is sealed to the housing 12 during manufacture of the cell 10, a hole 46 is drilled in the corner of the cell 10 above the first tube 32, e.g. a ⅜ inch hole. A grommet 48, which acts as a seal between the second tube section 34 and the cell cover 14, is inserted into the hole 46. The second tube section 34, with a connection fitting 50 connected to the top end of the second tube section 34, and a 45 degree angle cut 52 on its bottom end, is inserted into the hole 46 through the grommet 48 and down into the first tube section 32 until the fitting 50 is fully seated in the grommet 48. Thus it is appreciated that by installing the tube 32 in the corner of the cell 10, installation of the second tube section 34 into the first tube section 32 is facilitated. It is also appreciated that the length of the second tube section 34 is chosen to allow it to be inserted into the first tube 32. The length of the second tube 34 should extend a suitable distance into the first tube and can extend close to the bottom of the first tube 32 if desired. The outer diameter of the second tube 34 should be sized to slidably and snugly fit within the first tube 32 and to minimize air leakage from the top of the tube 32. The fitting 50 is chosen for the specific type of connection to a gas supply or distribution tube as to be described below. For example, the T fitting shown is useful if the cooling gas supply will be connected to the tube 30 in series with other cells 10 and thus one side of the fitting is for the gas in and the other side for delivery of gas to other cells, an L fitting can be used if this cell is the end of the supply line, or a 90 degree T fitting for corners.

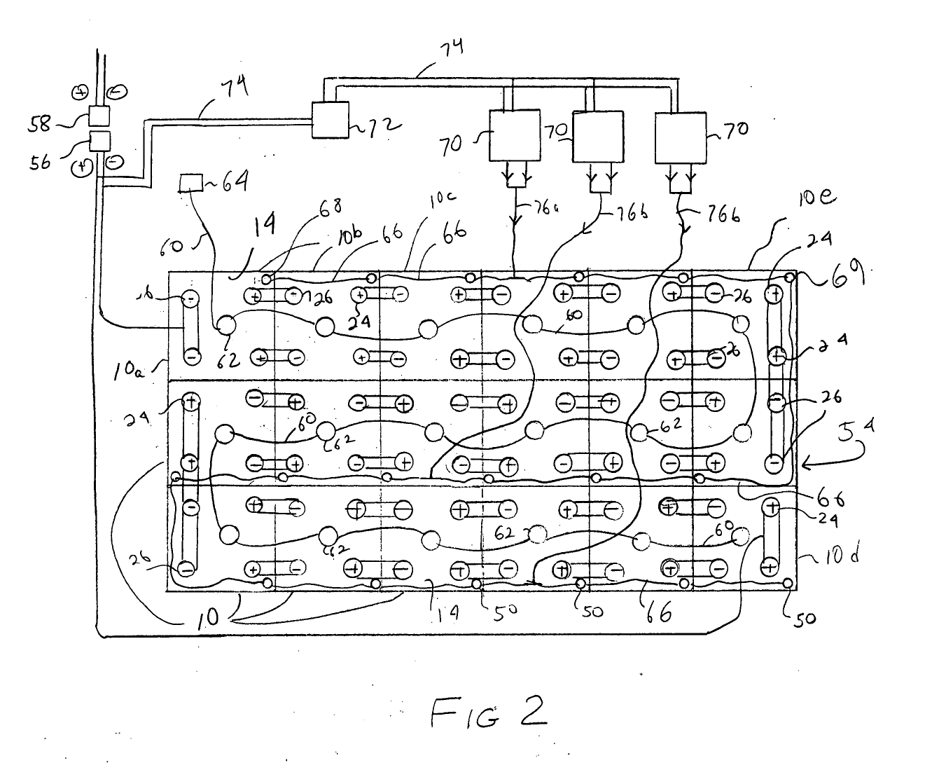

The cooling gas is preferably supplied by a gas distribution system that can serve all of the cells 10 of a given battery. While any suitable non-saturated gas (not saturated with water vapor) can be used, non saturated air is preferred, and the less saturated (dryer), the better. An example of a preferred cooling air supply and distribution system is illustrated with reference to FIG. 2 which shows a top view of a battery 54 made up of eighteen cells 10. The cells 10 are connected in series as known in the art to form a battery 54 such as those used for electric vehicles. Looking down on the covers 14 of the cells 10, it is seen that the cells 10 have positive and negative terminals 24, 26 connected electrically in series to one another, and the battery has a main electrical connector 56 for connecting the battery 54 to the load connector 58, e.g., the vehicle. Also shown is a watering system for adding water to the batteries as is known in the art, the illustrated water system having water tubing 60 connecting each water flow valve 62 of each cell 10 to a water supply (not shown) via a quick connect connector 64.

Although any air or fluid conduit means may be used, the preferred embodiment uses a flexible clear air supply tubing 66 to connect in series each of the cooling air fluid conduits 28 of each cell 10. Any suitable material, such as PVC tubing may be used. For example, beginning with the cell 10a in the upper left corner of the battery 54 as seen in FIG. 1, it is seen that an L fitting 68 connects the fluid conduit 28 extending into the cell 10a (here the second tube section 34 as seen in FIG. 1) to the supply tubing 66 which is also connected to the T fitting for the adjacent cell 10b, which is followed by cell 10c (with a T fitting) and so forth until the end or last cell 10d is reached where another L fitting is used to terminate the cooling supply line 66. The cell 10e in the upper right hand corner illustrates the use of a 90 degree T fitting 69. Thus it is seen that the supply tubing 66 connects in series to all the cells 10.

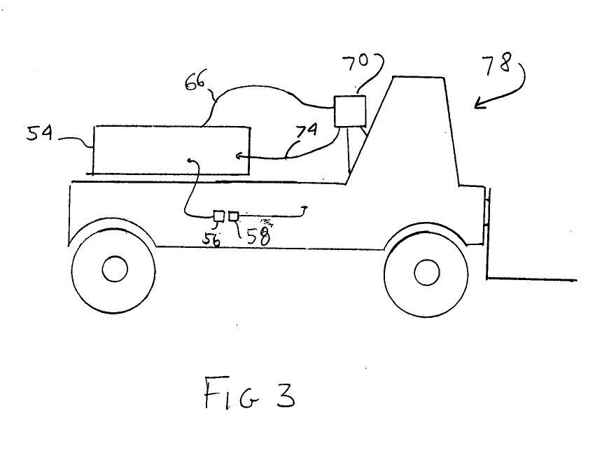

Air pumps 70 provide the cooling air to the cooling air supply tubing 66. In the preferred embodiment, three pumps 70 are provided for redundancy, each pump 70 having two diaphragm pump units (and thus two outlets), and have AC brushless motors for long life. The pumps 70 are preferably driven off of the battery 54 itself, an inverter 72, shown electrically connected between the pumps 70 and battery 54 by wires 74, being provided to convert the direct current of the battery 54 to alternating current. The pumps 70 are wired across the battery and not a smaller number of cells 10 so as not to discharge the smaller group of cells. The three pumps 70 can be mounted in a common box and mounted to the battery 54 or preferably on the vehicle and connected to the air supply tubing 66 with quick connects (not shown). Mounting on an electric vehicle 78, here a fork lift truck, is illustrated in FIG. 3 with the pumps 70 are wired to the battery 54. The pumps should preferably be mounted above the elevation of the battery 54 to eliminate the possibility of any electrolyte 18 from the cells 10 entering the pumps 70.

It is preferable to connect the various pumps 70 to the cooling supply tubing 66 at different points along the tubing 66. For example, in the eighteen cell battery 54 illustrated in FIG. 2, the three pumps 70 each have their dual supply outlets combined into single supply outputs 76a, 76b and 76c, which connect to the supply tubing 66 between cell number 3 and 4, 9 and 10, and 15 and 16 counting from the upper left hand corner of the battery 54 moving to the right, from right to left in the middle row, and from left to right in the bottom row of cells 10. For a 12 cell battery, the air supply connections are preferably between cell numbers 2 and 3, 6 and 7, and 10 and 11. For a 24 cell battery, the air supply connections are preferably between cell numbers 4 and 5,12 and 13, and 20 and 21.

Having described the various elements and components of the cooling system, the cooling process itself is now described. With reference to FIG. 1, it is seen that the gas, preferably air having been delivered to the electrolyte 18 via the pumps 70 and conduit 66, contacts the electrolyte 18. In the preferred embodiment, this contact is in the form of intermixing the gas with the electrolyte 18 by providing bubbles 40 of gas which mix with the electrolyte as they float up to the surface 19 of the electrolyte 18, after exiting the openings 38 of the fluid conduit 28. The physical movement of the air bubbles (40) mixes the acid electrolyte in a lead-acid cell and prevents stratification. Moreover, bubbles 40 of relatively dry air absorb moisture from the water in the electrolyte 18 and carry it out of the cell 10 as water vapor. Since it takes energy to provide the latent heat of evaporation of the water, that energy is removed from the cell, which reduces the temperature of the remaining electrolyte. This is an evaporative cooling effect. Preferably the air is as dry as possible so, especially in a stationary air supply, a desiccant or other dryer may be used to dry the air before letting it enter the cells 10. Direct air cooling, i.e., chilling of the air, has some effect but it is slight compared with evaporative cooling due to the low specific heat of air.

Instead of minimizing water evaporation from the electrolyte as was previously believed desirable, the present invention desirably causes evaporation. That is, it ignores the need to conserve water but rather encourages its evaporation to maximize cooling. To compensate for rapid water loss, a single-point watering system is used with the battery 54 to replace the evaporated water quickly and efficiently. Such systems are well known in the art, an example of one being described in U.S. patent application Ser. No. 10/694,276 filed Oct. 27, 2003 and which is hereby incorporated by reference herein.

The present invention, contrary to what is done conventionally, such as in conventional air mixing, may be set to provide cooling air continuously, day and night, indefinitely, if necessary. The charging process can add significant amounts of heat to the electrolyte 18 which may require the cooling process to run long after the charging cycle is over to remove the heat added. The effect on cooling of the battery is roughly proportional to the on time of the air flow so the present invention cools the battery very effectively. The on time can total 24 hours per day, and run during all cycles, i.e., charging, discharging, and idle or rest times (an example of rest being weekends when the vehicle may not be in use). A battery that is out of service, such as one removed from the vehicle and waiting for disposal, or a battery that is out of service for a significant length of time, need not be cooled. Although the air flow may be continuous at all times, in an alternative embodiment, it may be controlled by at least a simple thermostat 82 configured to control the pumps 70, switching on the air flow when the battery temperature rises above a set point and switching it off when the temperature drops below another set point. The thermostat could, for example, be connected to an electronic controller that controls the pumps. Other simple controls may consist of fixed or adjustable on/off timers or other more sophisticated controls as would be obvious to those familiar with batteries. For example the run time for the cooling air could be about 4 hours per day or more. As another possibility, the cooling system may be switched on and off periodically in any variety of ways. For example, an advanced predictive algorithm the controller may sense immediately when a high-rate charge is taking place and switch on the air flow as the heat is being generated and before a high battery temperature has been reached.

For lead-acid cells, the air flow may also be switched on independently of temperature for the additional function of de-stratifying the electrolyte 18 during charge even if the battery 54 is cool. For example, 2 minutes every 30 minutes during charge will suffice.

The cooling effect of the air flow is believed largely a function of evaporation of the water in the electrolyte (although some minor direct heat transfer will take place) so humid air will reduce the cooling rate substantially. For example, air having 100% humidity (saturated air) will provide no evaporation. The preferred application, therefore, is in locations where the air is not saturated, and preferably dry and relatively cool. However, the air may be dried with a desiccant or other type of air dryer inserted in the path of the air flow before being admitted into the cells 10 to maximize its evaporative effect.

For a given volume of air delivered to the cell 10, evaporation is increased as the size of the bubbles 40 is reduced. Thus a porous diffuser at the end of the fluid conduit 28 to generate microscopic bubbles 40 may be desirable.

Another consideration is the amount of cooling air flow used per cell 10. Once again, conventional air-mix systems seek to avoid water loss and, therefore, use relatively low air flow rates, e.g., 100 ml to 200 ml per minute per cell. The volume of air flow in the present invention may be anywhere from 100 ml to 2,000 ml per minute per cell 10, although these rates are not absolutes, but preferred examples.

Where the air comes from and how it is delivered is not relevant. It may come from a stationary source or a source on the truck or the battery. Any gas if available may be substituted for air, for example, nitrogen in cylinders. If the air comes from a stationary source, and the battery is on the truck, the cooling will obviously be limited to the periods when the charger is connected to the battery. Due to the nature of the rapid charge process, that may only be a small fraction of a 24 hour day and will limit the degree of cooling. However, with sufficient air flow in a dry condition, that may be an acceptable solution. A preferred embodiment, however, is that the air is supplied from a source on the truck 78 or the battery 54 itself, where it may be used to cool the battery at all times, day or night, during charge and during discharge, as required. If the air source is on the truck or battery, the control system for the air flow should preferably be on the truck or battery. A benefit of placing the air source on the truck or battery is that if a high rate of air-flow is used during discharge, the capacity of the battery can be enhanced due to the rapid movement of the electrolyte. As one example, a high flow rate of air may be released into the battery when the he controller senses a heavy load on the battery.

An added benefit of the present cooling system is that the use of large amounts of air flow into a cell 10 dilutes any hydrogen gas inside the cell gas space, reducing it explosive intensity, and thereby providing a further safety feature for the present invention.

A field test was run using the present invention on a large fork truck that was powered by twin batteries (1000 ampere hour cells). One battery was equipped with a continuously running evaporative cooling system according to the present invention and the other battery was unmodified. For the cooling system, air was provided at about 200 cc/min per cell, 24 hours a day. The air was provided by a DC pump drawing air from an air conditioned space. After two weeks of continuous operation in a rapid-charge environment, in which each battery was subject to precisely the same conditions, the evaporative cooled battery had an average temperature 15 deg F. (8.3 deg C.) lower than the unmodified battery.

Thus it is appreciated that the present invention can lower the average temperature of electrolyte 18 over a given time period, for example 24 hours, as compared to a similar cell or battery that does not incorporate the present invention. Average temperatures can be at least 5, 10 even 15 or more degrees F. lower than that of an electrolyte in the absence of the present cooling system over a given time period, such as a 24 hour time period that can include one or more charges of the battery (charging can take place numerous times in a given day, and each charge can be for a different amount of time, e.g., 20 minutes, one hour, two hours or six hours).

It is understood that the above-identified arrangements are merely illustrative of the many possible specific embodiments which represent applications of the present invention. Numerous and varied other arrangements can readily be devised in accordance with the principles of the invention without departing from the spirit and scope of the invention.

What is claimed is:

1. A method of cooling an aqueous electrolyte battery cell by causing the evaporation of water from the electrolyte, said method comprising;
(a) delivering non-saturated gas to the electrolyte of said battery;
(b) contacting said non-saturated gas with said electrolyte so that water from said electrolyte evaporates and thereby cools said electrolyte via an evaporative cooling process; and
(c) allowing said intermixed gas to escape from said battery cell.

2. The method of claim 1 wherein step (a) comprises delivering at least 200 ml per minute of said gas to said battery cell.

3. The method of claim 1 wherein said gas comprises air.

4. The method of claim 3 wherein step (b) comprises:
directing said gas via a gas conduit to an area adjacent a bottom of said battery cell where said gas exits said conduit; and
allowing said gas to bubble up through said electrolyte to a surface of said electrolyte.

5. The method of claim 3 comprising the step of continuing steps (a) through (c) continuously for at least 24 hours.

6. The method of claim 1 wherein the cooling process is effective to keep a temperature of said electrolyte at least 5 degrees F. lower on average over a 24 hour period as compared to said electrolyte in absence of said cooling method, which 24 hour period includes at least one charging of said cell in the beginning of said 24 hour period.

7. The method of claim 1 further comprising the step of continuing steps (a) through (c) during the entire charging time of said battery cell.

8. The method of claim 1 further comprising the step of continuing steps (a) through (c) during discharge of said battery cell.

9. The method of claim 1 further comprising the step of continuing steps (a) through (c) during the entire discharge time of said battery cell.

10. The method of claim 1 further comprising the step of continuing steps (a) through (c) during both charging and discharging of said battery cell.

11. The method of claim 4 wherein said pump is mounted on a vehicle powered by said battery cell, and said air is delivered to said battery cell via a conduit.

12. The method of claim 1 further comprising the step of continuing steps (a) through (c) during charging, discharging, and rest periods of said battery cell.

13. The method of claim 1 further comprising the steps of:
monitoring a temperature of said electrolyte; and
delivering or not delivering said gas to said electrolyte based on the temperature of the electrolyte.

14. A method of evaporative cooling a battery formed of multiple battery cells, each of said cells having an aqueous electrolyte within a cell housing, said method comprising:
(a) delivering non-saturated air to the electrolyte of each of said cells via an air pump powered by said battery;
(b) bubbling said non-saturated air through said electrolyte in each of said cells so that water from said electrolyte in each of said cells evaporates; and
(c) allowing said bubbled air to escape from said battery housing.

15. The method of claim 14 further comprising the step of continuing steps (a) through (c) during both charging and discharging cycles of said battery cell.

16. The method of claim 14 further comprising the step of turning said pump on and off to control the cooling method in response to a temperature of said electrolyte.

17. The method of claim 15 further comprising the step of lowering the humidity of said air before delivering it to said cells.

18. The method of claim 14 further comprising the step of cooling said air before delivering it to said cells.

19. A battery having an electrolyte cooling system, said battery comprising:
at least one battery cell having a housing;
positive and negative electrodes positioned within said housing;
an aqueous electrolyte within said housing in contact with said electrodes;
a housing cover having a vent through which air can vent from said housing;
a fluid conduit extending from outside said cell into said electrolyte and having an outlet positioned in a lower half of said electrolyte; and
an electric air pump connected to said fluid conduit and connected electrically to said battery to be powered there from.

20. The battery of claim 19 comprising a plurality of said battery cells, each of said cells having a said housing, said electrodes, said electrolyte, a said housing cover having a vent, and a said fluid conduit, and wherein said pump is fluidly connected to all of said fluid conduits.

21. The battery of claim 20 wherein said pump is powered by alternating current, and said device further includes means for converting direct current from said battery to alternating current to power said pump.

22. The battery of claim 20 further comprising at least one external fluid conduit connecting said pump to said fluid conduit of each of said battery cells.

23. The battery of claim 20 wherein said pump comprises multiple said pumps.

24. The battery of claim 19 wherein said fluid conduit comprise a first tube positioned within said housing extending through said electrolyte towards a bottom of said housing, and a second tube extending from outside said housing to said first tube inside said housing.

25. The battery of claim 19 wherein said fluid conduit comprise a tube having at least one said outlet positioned on a side of said tube spaced from a bottom of said tube.

26. The battery of claim 19 wherein said fluid conduit comprises a tube extending through said electrolyte to a bottom of said cell, said outlet being formed in said tube and positioned adjacent the bottom of said electrodes.

27. The battery of claim 19 wherein said pump is mounted to said battery.

28. An electric vehicle comprising:
a battery mounted on said vehicle and formed of a plurality of cells, each of said cells having an aqueous electrolyte, positive and negative plates immersed in said electrolyte, a vent to allow gasses to escape from said cell, and a fluid conduit disposed within said electrolyte and having an opening positioned adjacent a bottom of said plates;
an air pump electrically powered by said battery; and
a conduit connecting said air pump to said fluid conduit to deliver air from said pump to said electrolyte of said cells.

29. The vehicle of claim 28 wherein said pump is mounted on said vehicle.

30. A method of cooling a liquid electrolyte contained in at least one battery cell that has been charged, comprising contacting said electrolyte with a non-saturated gas in an amount and under conditions effective to remove a substantial portion of heat added to the electrolyte during the charging process.

31. A method of cooling a liquid electrolyte contained in at least one battery cell that has been charged, comprising contacting said electrolyte with a non-saturated gas in an amount and under conditions effective to keep the temperature of the electrolyte at least about 5 degrees F. lower on average over a 24 hour period as compared to said electrolyte absent said cooling method, which 24 hour period includes at least one charging of said cell in the beginning of said 24 hour period.

32. A method in accordance with claim 31 wherein said cooling is effective to keep the temperature of the electrolyte at least about 10 degrees F. lower on average over said 24 hour period.

33. A method in accordance with claim 31 wherein said cooling is effective to keep the temperature of the electrolyte at least about 15 degrees F. lower on average over said 24 hour period.

34. The method of claim 31 wherein said contacting of said electrolyte with a non-saturated gas is carried out by bubbling air through said electrolyte.

35. The method of claim 32 wherein said contacting of said electrolyte with a non-saturated gas is carried out by bubbling air through said electrolyte.

36. The method of claim 33 wherein said contacting of said electrolyte with a non-saturated gas is carried out by bubbling air through said electrolyte.

37. The method of claim 31 wherein the total time of all charging is at least 2 hours within said 24 hour time period.
